(19) United States
(12) Patent Application Publication
(10) Pub. No.: US 2015/0013511 A1
(43) Pub. Date: Jan. 15, 2015

(54) VERTICAL LATHE

(71) Applicant: ELHA MASCHINENBAU LIEMKE KG, Hovelhof (DE)

(72) Inventors: Dieter Renneke, Hovelhof (DE); Volker Ploger, Bielefeld (DE)

(21) Appl. No.: 14/370,710

(22) PCT Filed: Jan. 22, 2013
(86) PCT No.: PCT/EP2013/051118

§ 371 Date: Jul. 3, 2014

(30) Foreign Application Priority Data
Jan. 26, 2012 (DE) 202012100266.3

(51) Int. Cl. B23Q 11/12; B23B 3/14; B23Q 1/52

(52) U.S. Cl. CPC B23Q 11/127; B23Q 1/52; B23B 3/14; B23B 2250/12
USPC 82/122

(57) ABSTRACT

A vertical lathe includes a lower table and a working table, preferably a circular table, mounted on said lower table and rotatable in relation thereto about a vertical axis by means of a travelling-field motor, for receiving a workpiece, especially a workpiece to be machined, wherein the travelling-field motor is in operative connection with a heat-removing heat exchanger.

### CROSS-REFERENCE TO RELATED APPLICATION(S)

This is a U.S. National Stage of International Patent Application No. PCT/EP2013/051118, filed Jan. 22, 2013, and to German Priority Patent Application No. DE 20 2012 100 266.3, filed Jan. 26, 2012, the entire contents of both of which are incorporated herein by reference.

### FIELD OF THE INVENTION

The invention relates to a vertical lathe.

### DESCRIPTION OF RELATED ART

Such a vertical lathe is known from DE 20 2009 008 850 U1 for example. It discloses that a travelling-field motor is used as a motor, whose primary segments forming the stator are positioned in the bottom table and the secondary segments forming the rotor are positioned in the working table.

This vertical lathe has proven to be extraordinarily successful concerning its functionality. However, problems can arise by the heat which is produced during operation of the travelling-field motor, since thermal tensions occur in the involved components such as the working table, which tensions will lastly have an influence on the machining precision.

Since especially large precision parts such as bearing rings and rotors of wind turbines or the like are produced with such a vertical lathe, the uncontrolled increase in heat of the respective carrier components and the resulting disadvantages are especially relevant.

### SUMMARY OF THE INVENTION

The invention is based on the object of further developing a vertical lathe of the kind mentioned above in such a way that its usefulness is improved.

This object is achieved by a vertical lathe according to the present invention.

In accordance with the invention, the travelling-field motor is in operative connection with a heat-removing heat exchanger, which absorbs the heat produced by the travelling-field motor in operation and dissipates said heat, for which purpose a suitable medium is used.

Since especially the secondary segments of the travelling-field motor which forms the rotor produce heat during operation and said secondary segments are held on the working table, the heat exchanger is also preferably arranged on the working table in direct contact with the secondary segments.

The heat exchanger, in its capacity as a heat sink, is preferably made of a material that conducts heat very well, e.g. aluminium or the like, and is preferably positioned between the secondary segments and the working table.

In order to prevent heat transmission between the heat exchanger and the working table, a preferably plate-like insulation is provided as an intermediate layer.

The heat exchanger can be arranged in such a way that the cooling medium flows about said heat exchanger at least in sections, which cooling medium is held in an annular cooling chamber and can be supplied in a circuit to a separate cooler.

The cooling chamber can be provided in an outer peripheral region of the vertical lathe and is used simultaneously as a liquid seal, by means of which a substantially hermetic sealing of the travelling-field motor is achieved both in the bottom table and also in the working table.

It needs to be mentioned further that the new vertical lathe can be realised with relatively little effort concerning construction and production. It is necessary in this respect that the secondary elements are screwed together with the heat exchanger, wherein they rest on the heat exchanger over the entire surface, which heat exchanger is massively arranged so that optimal heat transmission is provided from the secondary elements to the cooling medium, which preferably consists of a suitable oil.

Further advantageous embodiments of the invention are made apparant by the discussion that follows.

### DESCRIPTION OF THE DRAWINGS

An embodiment of the invention will be described below by reference to the enclosed drawings, wherein:

FIG. 1 shows a vertical lathe in a front view;

FIG. 2 shows the vertical lathe in a top view;

FIG. 3 shows a partial sectional view of the vertical lathe according to the line III-III in FIG. 2; and

FIG. 4 shows an enlarged detail of the vertical lathe according to the reference IV in FIG. 3.

### DETAILED DESCRIPTION OF EMBODIMENT(S) OF THE INVENTION

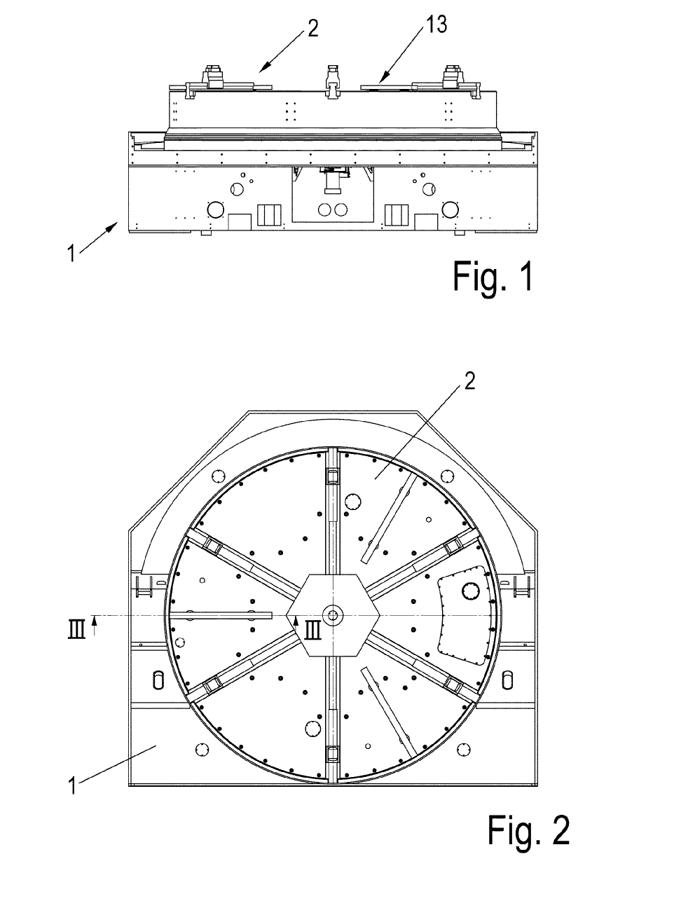

FIGS. 1 and 2 show a vertical lathe, comprising a bottom table 1 and a working table 2 which is mounted thereon and is rotatable in relation thereto about a vertical axis by means of a travelling-field motor 3, and which working table is arranged as a circular table for accommodating at least one workpiece to be machined by metal-cutting.

The travelling-field motor 3 consists in the known manner of primary segments 4 forming a stator and secondary segments 5 forming a rotor. The primary segments 4 are fixedly positioned in the bottom table, whereas the secondary segments 5 are held on the working table 2, wherein the mutually facing effective surfaces of the primary segments 4 and the secondary segments 5 extend in a horizontal plane by forming an air gap.

The travelling-field motor 3 is in operative connection with a heat-removing heat exchanger 6 in accordance with the invention, which heat exchanger is fixed to the working table 2 in the example and on which the secondary segments 5 rest over the entire surface and are fastened thereto by a screwed joint.

The heat exchanger 6 is preferably arranged in an annular fashion and is situated in the peripheral region of the working table 2, as also the travelling-field motor 3.

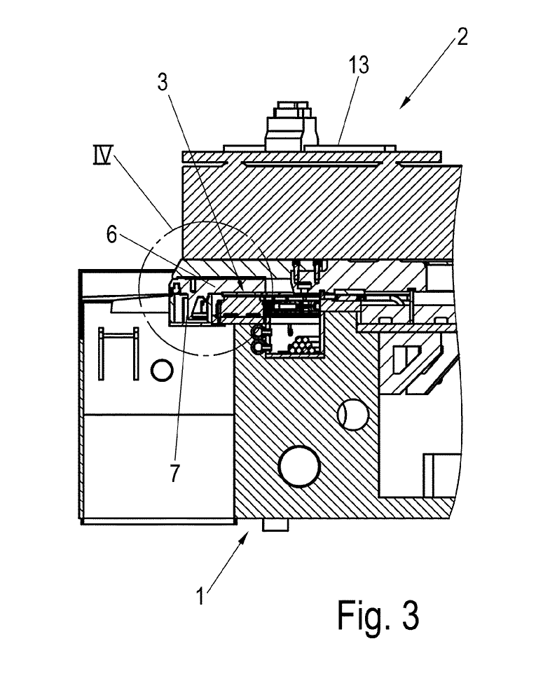

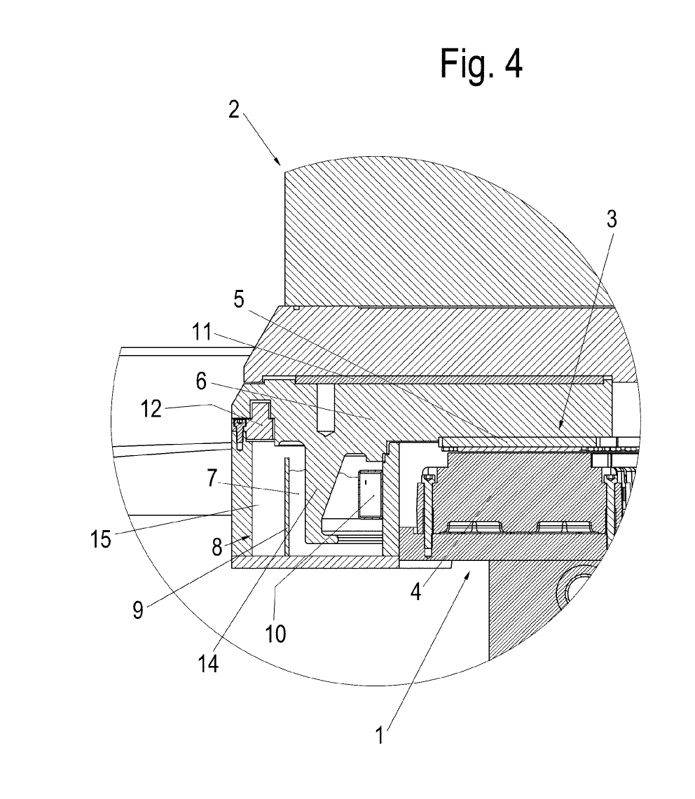

An insulating layer 11 is provided on the bottom side of the working table 2 which faces away from a workpiece fixture 13 between the heat exchanger 6 and the region of the working table 2 situated above said heat exchanger (FIG. 3), wherein the insulating layer 11 is dimensioned in such a way that the heat exchanger 6 rests thereon, which heat exchanger incidentally consists of a massive part of a material with good heat-conducting properties, especially a metal such as aluminium, copper or the like. In cooperation with the heat exchanger 6, the insulating layer 11 effectively prevents that heat developed during the operation of the vertical lathe passes through the secondary segments 5 into the working table 2, so that it remains evenly tempered irrespective of operation.

For the purpose of removing the heat from the heat exchanger 6, it comprises a concentrically extending leg 14 which protrudes into a cooling chamber 7 of the bottom table 1 and where a cooling medium flows around said leg 14, which cooling medium is held in the cooling chamber 7 and can be guided into the cooling chamber 7 by way of a circuit via a cooling unit (not shown) and a connected coolant supply 10.

The cooling chamber 7 is a component of a liquid seal 8, which comprises a sealing chamber 15 in addition to the cooling chamber 7, which are both separated by a vertically aligned concentric web 9, wherein the sealing chamber 15 simultaneously forms a discharge for the cooling medium.

In the outermost peripheral region, the rotating working table 2 is sealed in relation to the opposite stationary bottom table 1 by a labyrinth seal 12, so that no dirt will reach the region of the travelling-field motor 3 in correspondence with the liquid seal 8.

1. A vertical lathe, comprising a bottom table and a working table, preferably a circular table, mounted on said bottom table and rotatable in relation thereto about a vertical axis by means of a travelling-field motor, for accommodating a workpiece, especially a workpiece to be machined by metal-cutting, characterized in that the travelling-field motor is in operative connection with a heat-removing heat exchanger.

2. The vertical lathe according to claim 1, wherein the heat exchanger is fixed to the working table.

3. The vertical lathe according to claim 1, wherein the heat exchanger is in contact with a cooling medium, preferably a cooling liquid.

4. The vertical lathe according to claim 1, wherein secondary segments, which form a rotor of the travelling-field motor, are fixed to the heat exchanger.

5. The vertical lathe according to claim 1, wherein the heat exchanger comprises a material that conducts heat.

6. The vertical lathe according to claim 1, wherein the heat exchanger comprises a leg which dips into a cooling chamber which accommodates the cooling medium.

7. The vertical lathe according to claim 1, wherein the cooling medium is cooled in a circuit via a connected cooling unit.

8. The vertical lathe according to claim 6, wherein the cooling chamber is a component of a liquid seal.

9. The vertical lathe according to claim 6, wherein the cooling chamber is provided in the bottom table.

10. The vertical lathe according to claim 4, wherein an insulating layer is arranged on the side of the heat exchanger which faces away from the secondary segments.

11. The vertical lathe according to claim 4, wherein the secondary segments rest over the entire surface on the heat exchanger on its sides facing away from the primary segments.

12. The vertical lathe of claim 5, wherein the material that conducts heat comprises at least one of aluminum or copper.
